(19) United States
(12) Patent Application Publication
(10) Pub. No.: US 2019/0135365 A1
(43) Pub. Date: May 9, 2019

(54) Vehicle Mirror Adapter

(71) Applicant: Alan A. Jesse, Peoria, AZ (US)

(72) Inventor: Alan A. Jesse, Peoria, AZ (US)

(21) Appl. No.: 15/807,085

(22) Filed: Nov. 8, 2017

(51) Int. Cl. B62J 29/00; G02B 7/182

(52) U.S. Cl. CPC B62J 29/00; G02B 7/182

(57) ABSTRACT

A novel mirror adapter includes a body, a first coupling mechanism, a second mechanism, and a dampening assembly. The first coupling mechanism is coupled to the body and is configured to couple to a handlebar mirror receiver of a vehicle. The second coupling mechanism is coupled to the body and is configured to receive a mirror component. The dampening assembly is coupled between the first coupling mechanism and the second coupling mechanism and is configured to dampen the vibration between the first coupling mechanism and said second coupling mechanism. In a particular embodiment, the mirror adapter includes a lock assembly for locking items to a vehicle such as, for example, a motorcycle.

### BACKGROUND OF THE INVENTION

### Field of the Invention

This invention relates generally to motor vehicles, and more particularly to personal motor vehicle mirrors.

### Description of the Background Art

When riding a personal motor vehicles (e.g., motorcycles, snowmobiles, ATV, jet ski, etc.), safety is imperative. To maximize safety, it is important for the vehicle's mirrors to provide the driver with the clearest view possible. It is also important for the driver to wear plenty of safety gear such as, for example, a helmet, safety jacket, life jacket, etc.

FIG. 1A shows a perspective view of a prior art motorcycle handlebar assembly 100 and a side mirror assembly 102 shown exploded therefrom. While handlebar assembly 100 is for a motorcycle, many personal motor vehicles have handlebar assemblies.

Motorcycle handlebar assembly 100 includes handlebars 104, a mirror receiver 106, a control switch 108, and a grip 110. Mirror receiver 106 is bolted to handlebars 104 and includes a threaded aperture 112 that is configured to receive mirror assembly 102. Control switch 108 is representative of various types of control switches (e.g., engines kill switch, light controls, horn buttons, etc.) commonly mounted on handlebars.

Side mirror assembly 102 includes a coupling component 114, a locking nut 116, and a mirror 118. Coupling component 114 facilitates the adjustable coupling of mirror 118 to mirror receiver 106. Furthermore, coupling component 114 includes a first threaded end 120 and a second threaded end 122. First threaded end 120 threads into aperture 112 or mirror receiver 106, and second threaded end 122 includes a cylindrical recess 124 configured to receive a smooth cylindrical end 126 of a supporting structure 128 of mirror 118. With end 126 seated in recess 124, mirror 118 is fixed with respect to mirror receiver 106 by tightening nut 116 onto threaded end 122 of coupling component 114. Of course, the position of mirror 118 about an axis 130 can be adjusted by first loosening nut 116, then rotating mirror 118 about axis 130, and finally tightening nut 116 once mirror 118 is at a desired position.

FIG. 1B shows a front view of prior art handlebar assembly 100 and prior art side mirror assembly 102 in an assembled state. There are several problems associated with handlebar assembly 100 and side mirror assembly 102. For example, vibration from the engine, road, etc. is transferred through the frame, to handlebars 104, to support structure 128, and ultimately to mirror 118. Of course, such vibration is undesirable because it distorts the reflection in mirror 118, sometimes to an unsafe degree (image distortion not shown). As another example, mirror assembly 102 has a very limited range in terms of where it can be positioned with respect to the rider. That is, mirror 118 has a relatively short vertical height (H₁) and short horizontal distance (D₁) at which it is fixed with respect to handlebars 104. As shown, this limited range causes the rider's shoulder 132 to obstruct the view of the road behind him.

Another problem faced by operators of personal motor vehicles is that such vehicles are open and, therefore, susceptible to safety equipment theft. Consequently, operators are often reluctant to use such safety equipment or are burdened with carrying their safety equipment with them when off the vehicle.

### SUMMARY

The present invention overcomes the problems associated with the prior art by providing a mirror adapter that reduces vibration in vehicle mirrors, provides a means to lock items to the vehicle, and/or repositions the mirror for better rearview.

The mirror adapter includes a body having a top and bottom, a first coupling mechanism, a second coupling mechanism, and a dampening assembly. The first coupling mechanism is coupled to the body and configured to couple to a handlebar mirror receiver of a vehicle. The second coupling mechanism is coupled to the body and configured to receive a mirror component. The dampening assembly is coupled between the first coupling mechanism and the second coupling mechanism. Furthermore, the dampening assembly is configured to dampen vibration between the first coupling mechanism and the second coupling mechanism.

Various exemplary embodiments related to the first coupling mechanism are disclosed. In one particular embodiment, the first coupling mechanism includes at least one spacer configured to be disposed between the bottom of the body and the handlebar mirror receiver of the vehicle. In another particular embodiment, the first coupling mechanism includes an aperture extending through the top of the body to the bottom of the body. Further, the first coupling mechanism includes a fastener disposed in the aperture, and the fastener is configured to thread into the handlebar mirror receiver of the vehicle. In a more particular embodiment, the mirror adapter further includes a lock shank having an open end, the fastener includes a head defining a socket recess, and the open end of the lock shank is configured to be removably disposed in the socket recess.

Exemplary embodiments associated with the second coupling mechanism are also disclosed. For example, in one particular embodiment, the second coupling mechanism includes a nut configured to threadably engage the mirror component, and the dampening assembly includes a compression member (e.g., a polymer material, etc.) disposed between the nut and the body. Further, changing the amount of force exerted on the compression member by the nut and the body alters the vibration characteristics of the mirror component.

In a more particular embodiment, the nut includes a flange configured to engage the compression member. Still more particularly, the compression member has an annular geometry and is disposed around the nut.

In another more particular embodiment, a portion of the body defines an aperture extending through the top of the body to the bottom of the body. The aperture is configured to receive the mirror component, and at least a portion of the compression member is disposed in the aperture. The compression member compresses between the flange of the nut and the portion of the body defining the aperture responsive to tightening the nut onto the mirror component. Even more particularly, the mirror adapter includes a second compression member disposed between the top of the body and the mirror component, such that changing the amount of compressive force exerted on the second compression member by the body and the mirror component alters the vibration characteristics of the mirror component. Even more particularly still, the mirror adapter includes a washer configured to engage the second compression member such that the second compression member is disposed between the top of the body and the washer.

In still another more particular embodiment, the compression member is one of a plurality of interchangeable compression members, and each of the plurality of compression members has different vibration-reducing characteristics.

The second coupling mechanism can also be horizontally offset with respect to the first coupling mechanism such that the body can be adjustably fixed about an axis passing through the first coupling mechanism.

Particular embodiments associated with the dampening assembly are also disclosed. For example, in a particular embodiment, the dampening assembly includes a compression member disposed between the top of the body and the mirror component. Optionally, the compression member is one of a plurality of interchangeable compression members, each having different vibration-reducing characteristics. The dampening assembly can also further include a washer configured to engage the compression member, where the compression member is disposed between the top of the body and the washer. Optionally, the washer is one of a plurality of interchangeable washers, where each of the plurality of interchangeable washers has different vibration-reducing characteristics. Thus, in various embodiments, the dampening assembly is tunable.

The mirror adapter can also include a locking mechanism coupled to the body. In one example embodiment, the locking mechanism includes a lock shank, and in more specific embodiments, includes a barrel lock configured to selectively engage the lock shank and/or includes a variable radius coil spring disposed around the lock shank.

In a specific example of a mirror adapter with locking mechanism, the first coupling mechanism includes an aperture extending through the body from the top to the bottom and a bolt disposed in the aperture, which is configured to thread into the handlebar mirror receiver of the vehicle. The bolt includes a head defining a socket recess, and the lock shank includes an open end that is disposed in the socket recess when the locking mechanism is in a locked position and is removed from the socket recess when the locking mechanism is in an unlocked position. Additionally, the second coupling mechanism includes a nut configured to threadably engage the mirror component, and the dampening assembly includes a compression member disposed between the nut and the body. Changing the amount of force exerted on the compression member by the nut and the body alters the vibration characteristics of the mirror component.

Another mirror adapter described herein includes a body having a top and bottom, a first coupling mechanism, a second coupling mechanism, and a lock assembly. The first coupling mechanism is coupled to the body and configured to couple to a handlebar mirror receiver of a vehicle. The second coupling mechanism is coupled to the body and configured to receive a mirror component. The lock assembly is coupled to the body and configured to selectively lock objects to the mirror adapter.

In one example embodiment, the body includes a lateral face extending between the top and the bottom of the body and defining an aperture. The lock assembly is disposed between the first coupling mechanism and the second coupling mechanism within the aperture.

In another exemplary embodiment, the lock assembly includes a lock shank, and in a more specific example, includes a barrel lock coupled to the body and configured to selectively engage the lock shank. In a more specific example, the lock assembly can include a variable radius coil spring disposed around the lock shank, between the lock shank and the body.

In still another particular embodiment including a lock shank, the first coupling mechanism includes an aperture extending through the body from the top to the bottom and a fastener disposed in the aperture, which is configured to thread into the handlebar mirror receiver of the vehicle. The fastener includes a head defining a socket recess, and the lock shank includes an open end that is disposed in the socket recess when the lock assembly is in a locked position and removed from the socket recess when the lock assembly is in an unlocked position.

Methods of manufacturing mirror adapters are also described. One method includes providing a body having a top and bottom, providing a first coupling mechanism, providing a second coupling mechanism, and providing a dampening assembly. The first coupling mechanism is configured to couple to the body and further configured to couple to a handlebar mirror receiver of a vehicle. The second coupling mechanism is configured to couple to the body and further configured to receive a mirror component. The dampening assembly is configured to be coupled between the first coupling mechanism and the second coupling mechanism and is further configured to dampen vibration between the first coupling mechanism and the second coupling mechanism.

In one particular method, the step of providing the dampening assembly includes selecting a compression member from a plurality of compression members based on a model of the vehicle and providing the selected compression member as a component of the dampening assembly. Each of the plurality of compression members has different vibration-reducing characteristics.

According to another particular method, the step of providing the dampening assembly includes providing a plurality of interchangeable compression members, where each of the plurality of compression members has different vibration-reducing characteristics. More particularly, the step of providing the first coupling mechanism includes providing a fastener configured to be disposed through the body and threaded into the handlebar mirror receiver of the vehicle. Even more particularly still, the step of providing the first coupling mechanism includes providing one or more spacers configured to be disposed around the fastener between the body and the handlebar mirror receiver, where each of the one or more spacers is configured to raise the body above the handlebars by a predetermined amount.

In another particular exemplary method, the step of providing the second coupling mechanism includes providing a nut having thread specifications corresponding to the mirror component. In a more specific example, the step of providing the dampening assembly includes providing a plurality of interchangeable compression members, where each of the plurality of compression members has a different vibration reducing characteristic and is configured to be disposed between the nut and the body.

In still another particular exemplary method, the step of providing the dampening assembly includes providing a rigid washer configured to be disposed between the body and the mirror component and providing a compression member configured to be disposed between the rigid washer and the body. In a more specific example, the step of providing the dampening assembly includes providing a plurality of interchangeable rigid washers configured to be disposed between the body and the mirror component, where each of the rigid washers has a different vibration characteristic. In another more specific example, the step of providing the dampening assembly includes providing a plurality of interchangeable compression members configured to be disposed between the body and rigid washer, where each of the compression members has a different vibration characteristic.

Still another particular method includes providing a lock assembly configured to lock objects to the mirror adapter. Another method of manufacturing a mirror adapter includes providing a rigid body, providing a first coupling mechanism, providing a second coupling mechanism, providing a lock assembly, and coupling the lock assembly to the body. In this method, the first coupling mechanism is configured to be coupled to the body and to a handlebar mirror receiver of a vehicle, and the second coupling mechanism is configured to be coupled to the body and to receive a mirror component.

A method for installing a mirror adapter on a vehicle is also disclosed. The method includes installing a dampening system on a body of the mirror adapter and fastening the body to a handlebar mirror receiver of the vehicle via a first coupling mechanism. The method further includes fastening a mirror component to the body via a second coupling mechanism, where the second coupling mechanism is configured to adjustably compress the dampening system between the second coupling mechanism and the body. The method further includes adjusting the second coupling mechanism to apply compression on the dampening system sufficient to dampen vibration on the mirror component during operation of the vehicle.

One particular example method further includes the steps of observing vibration in the mirror during operation of the vehicle, and adjusting the compression on the dampening system to change the amount of vibration occurring in the mirror component during operation of the vehicle.

In another particular example method, the dampening system comprises a plurality of interchangeable compressible members, each having a different vibration characteristic. Additionally, the step of installing the dampening system includes installing one of the interchangeable compressible members between the second coupling mechanism and the body. Then, a more particular example method further includes the steps of observing vibration in the mirror component during operation of the vehicle and installing a different one of the interchangeable compressible members between the second coupling mechanism and the body if the observed vibration in the mirror is too great.

### BRIEF DESCRIPTION OF THE DRAWINGS

The present invention is described with reference to the following drawings, wherein like reference numbers denote substantially similar elements:

FIG. 1A is a perspective view of a prior art side mirror assembly exploded from a prior art motorcycle handlebar assembly;

FIG. 1B is a front view of the prior art side mirror assembly mounted on the prior art handlebar assembly of FIG. 1A;

FIG. 2 is a perspective view showing a mirror adapter according to the present invention indirectly mounting the side mirror assembly of FIG. 1A to the handlebar assembly of FIG. 1A;

FIG. 3 is a front view of the mirror adapter of FIG. 2 indirectly mounting the side mirror assembly of FIG. 1A to the handlebar assembly of FIG. 1A;

FIG. 4 is a top view of the mirror adapter of FIG. 2 indirectly mounting the side mirror assembly of FIG. 1A to the handlebar assembly of FIG. 1A;

FIG. 5A is perspective view of the mirror adapter of FIG. 2 in a locked state;

FIG. 5B is perspective view of the mirror adapter of FIG. 2 in an unlocked state;

FIG. 6 is an exploded perspective view of the mirror adapter of FIG. 2;

FIG. 7A is a rear perspective view of the body of the mirror adapter of FIG. 2;

FIG. 7B is a bottom perspective view of the body of FIG. 7A;

FIG. 8A is a cross-sectional rear view of the adapter of FIG. 2 in a locked state taken along line A-A of FIG. 5A;

FIG. 8B is a cross-sectional rear view of the adapter of FIG. 2 in an unlocked state taken along line B-B of FIG. 5B;

FIG. 8C is another cross-sectional rear view of the adapter of FIG. 2 in a locked state taken along line A-A of FIG. 5A showing an alternative means for securing a spring to a lock shank;

FIG. 9 is a front view of two of the mirror adapters of FIG. 2 mounted on opposite sides of the handlebar assembly of FIG. 1A and including a security cable fastened therebetween;

FIG. 10 is a front view showing a helmet secured to the mirror adapter of FIG. 2;

FIG. 11 is a flowchart summarizing a method of manufacturing a mirror adapter;

FIG. 12 is a flowchart summarizing another method of manufacturing a mirror adapter; and

FIG. 13 is a flowchart summarizing a method of installing a mirror adapter.

### DETAILED DESCRIPTION

The present invention overcomes the problems associated with the prior art, by providing a mirror adapter that reduces vibration in a mirror coupled thereto, provides a means for locking items to a vehicle, and/or repositions the mirror for better rearview. In the following description, numerous specific details are set forth (e.g., material types, lock types, etc.) in order to provide a thorough understanding of the invention. Those skilled in the art will recognize, however, that the invention may be practiced apart from these specific details. In other instances, details of well-known manufacturing practices (e.g., machining, forming compression members, etc.) and components have been omitted, so as not to unnecessarily obscure the present invention.

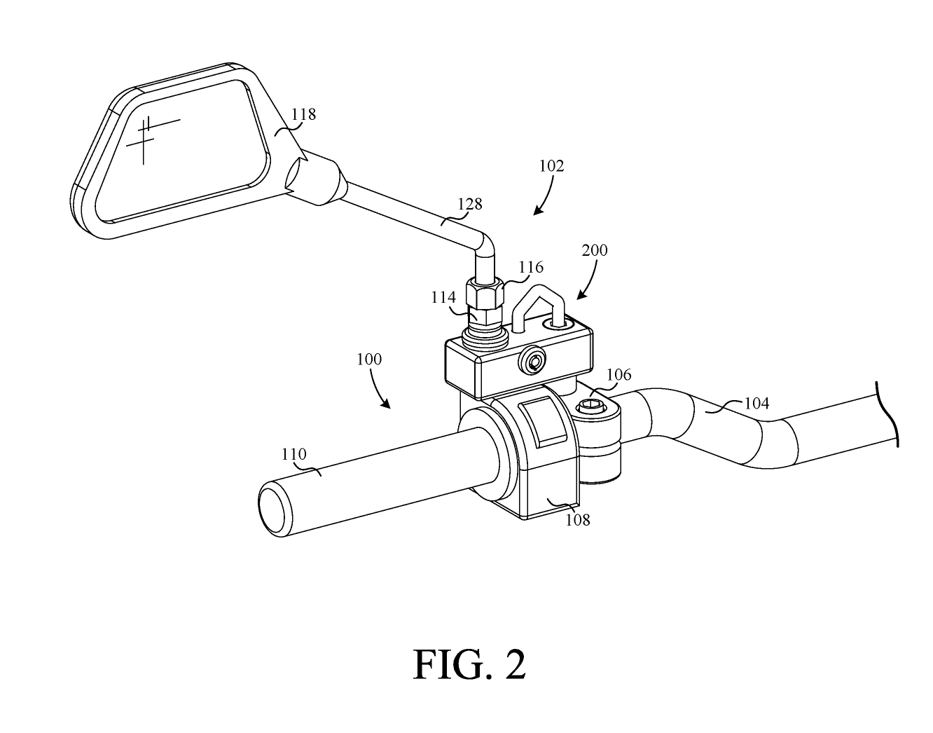

FIG. 2 is a perspective view of a mirror adapter 200 according to an embodiment of the present invention indirectly mounting side mirror assembly 102 to handlebar assembly 100. As will be described with reference to upcoming figures, mirror adapter 200 provides several advantages. For example, mirror adapter 200 substantially reduces the amount of vibration that is transferred to mirror 118 from handlebars 104 and the vehicle. As another example, mirror adapter 200 allows more equipment to be locked to the motor vehicle when left unattended. As yet another example, mirror adapter 200 provides a greater range of flexibility for mounting mirror 118 in a desired position, which improves rearview.

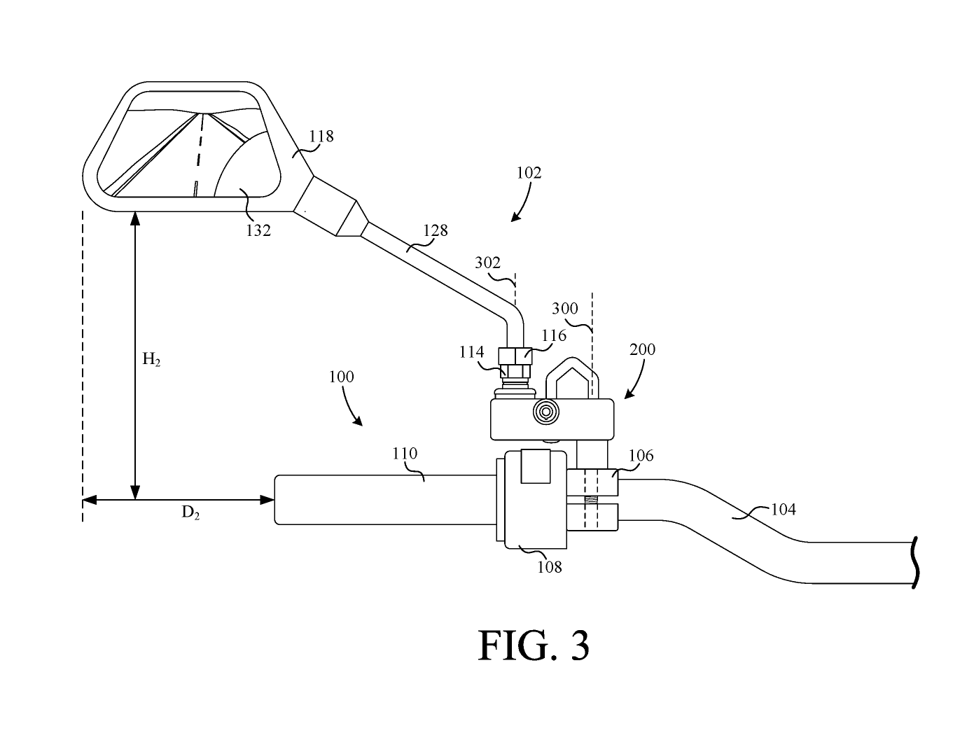

FIG. 3 is a front view showing mirror adapter 200 indirectly mounting side mirror assembly 102 to handlebar assembly 100. As shown, vibration imparted to support structure 128 and mirror 118 has been substantially reduced by mirror adapter 200, such that the view in mirror 118 is much clearer. As will be described below, mirror adapter 200 includes a tunable dampening assembly, which enables vibration to be dampened out of mirror 118.

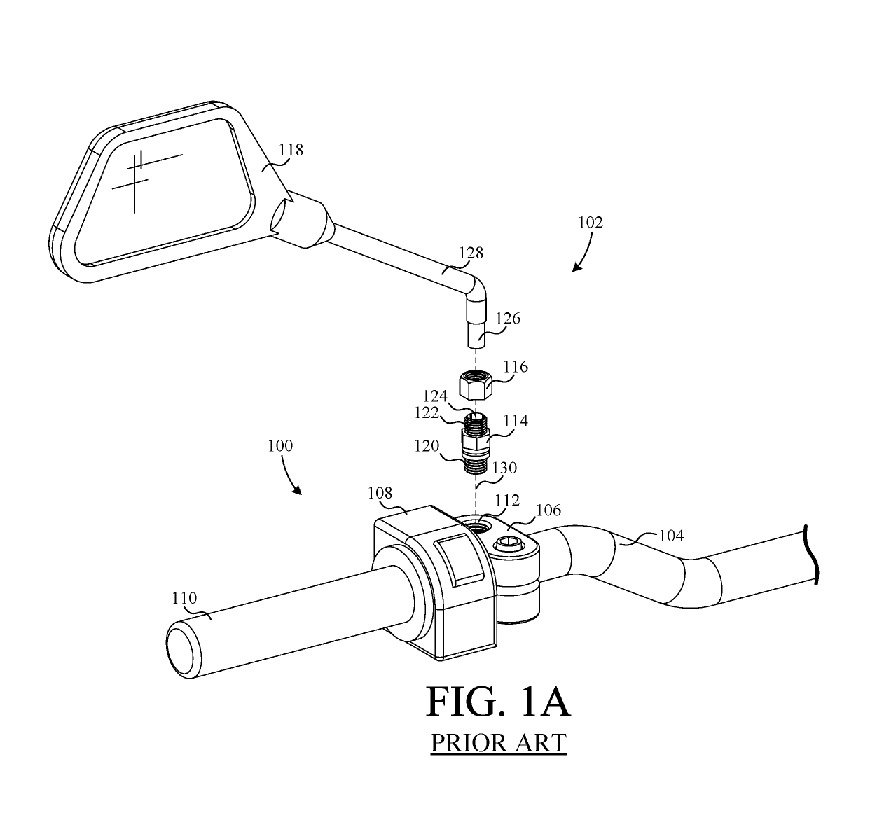

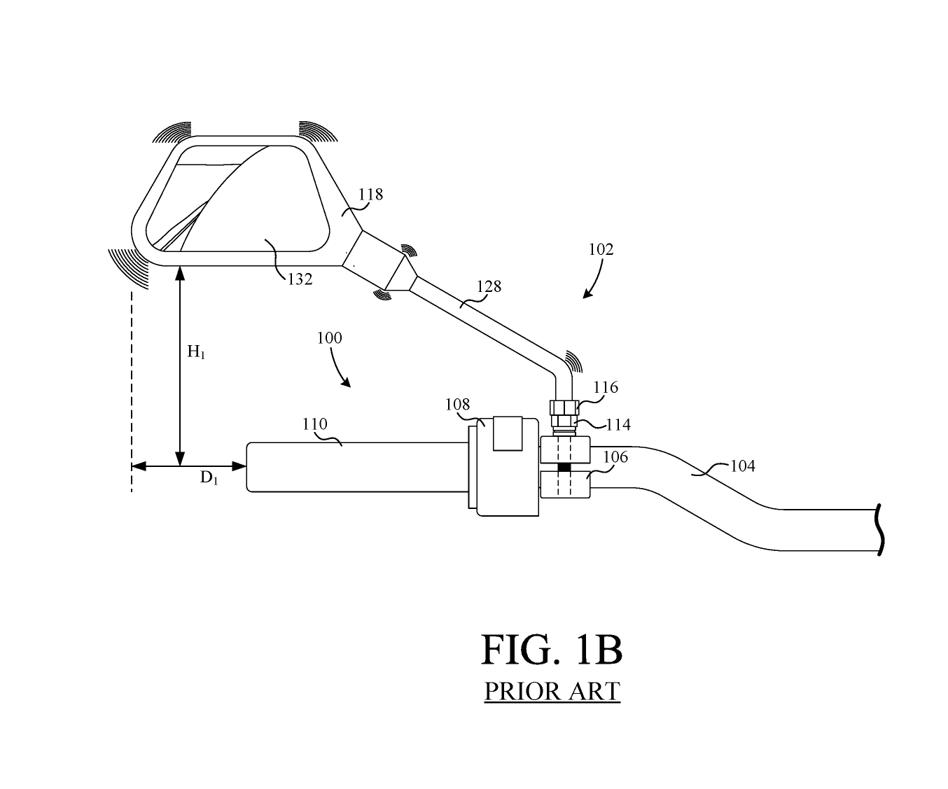

Additionally, FIG. 3 shows that the view of the road behind the driver is far less obstructed by the driver's shoulder 132. This is because mirror adapter 200 provides mirror 118 with a greater range of mounting positions. Indeed, H₂ and D₂ of FIG. 3 are greater than H₁ and D₁ of FIG. 1B, respectively, which moves mirror 118 upward and outward away from the rider's shoulder 132. The greater range of mounting positions is due in part to mirror adapter 200 being rotatable about a first axis 300 and support structure 128 being rotatable about a second axis 302 during the fixing of mirror 118 with respect to handlebars 104.

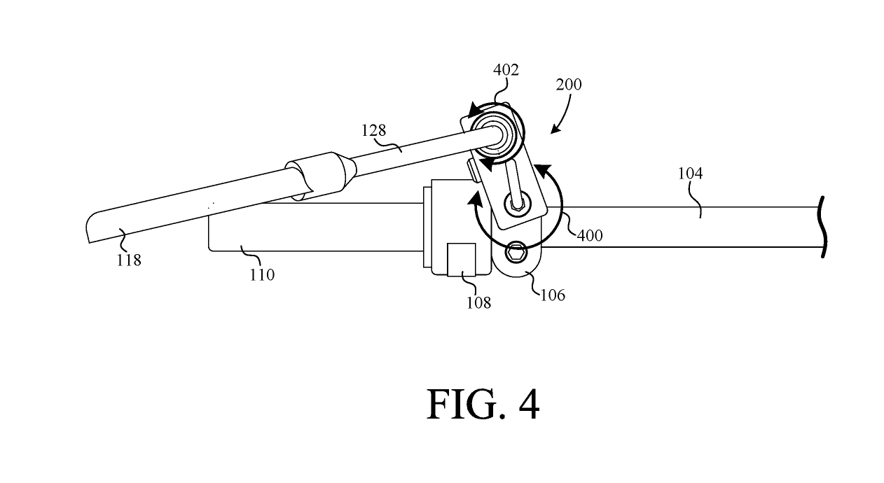

FIG. 4 is a top view showing ranges of adjustability that mirror adapter 200 provides when indirectly mounting mirror assembly 102 to handlebar assembly 100. Arrow 400 illustrates the rotation of mirror adapter 200 about axis 300. Likewise, arrow 402 illustrates the rotation of support structure 128 about axis 302. Not only does the additional degree of freedom provided by adapter 200 allow mirror 118 to be positioned further away from grip 110, it also allows mirror 118 (and the body of mirror adapter 200) to be rotated away from control switch 108 and/or positioned much closer to the center of the vehicle if so desired.

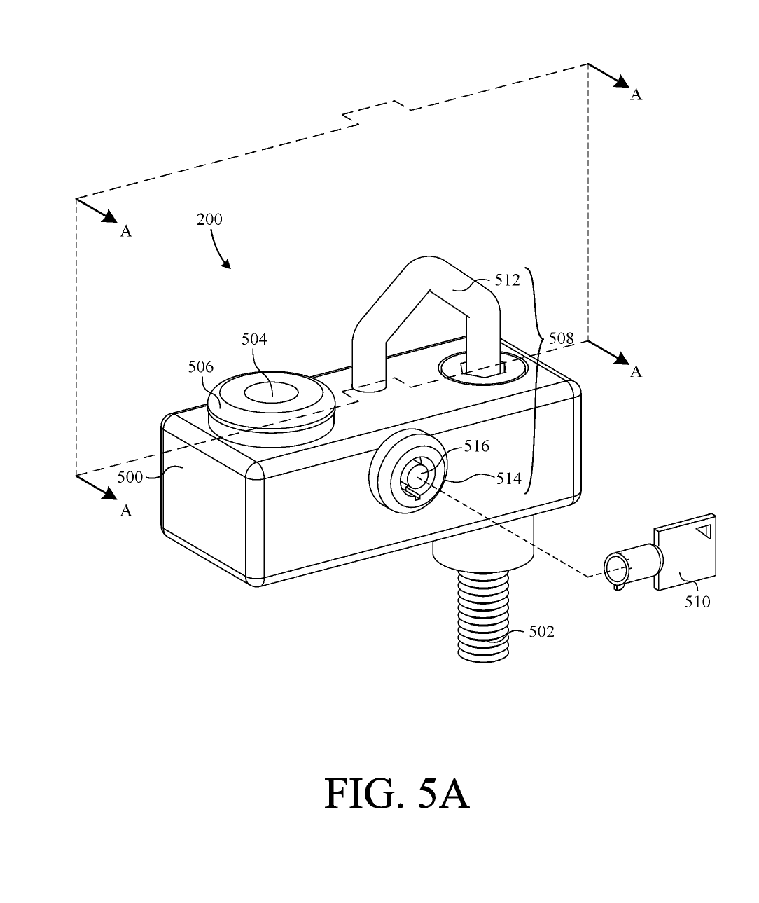

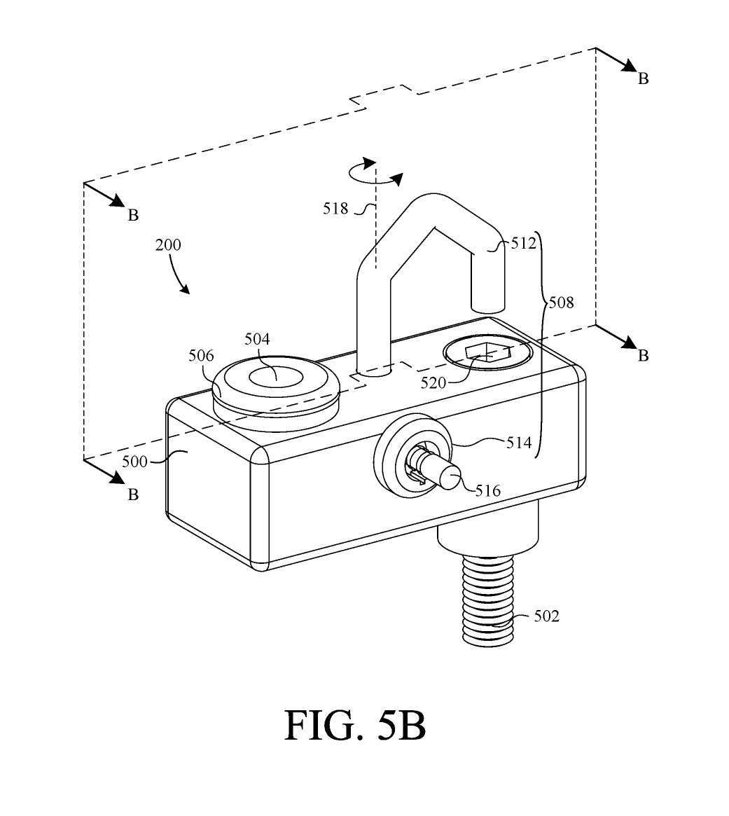

FIGS. 5A and 5B show perspective views of mirror adapter 200 in a locked state and an unlocked state, respectively, and removed from handlebar assembly 100 and mirror assembly 102.

Mirror adapter 200 includes a body 500, a first coupling mechanism 502, a second coupling mechanism 504, a dampening assembly 506, and a lock assembly 508. In the example embodiment shown, body 500 is a solid structure formed by machining a metal billet (e.g., aluminum, etc.) to receive first coupling mechanism 502, second coupling mechanism 504, dampening assembly 506, and lock assembly 508. First coupling mechanism 502 facilitates the coupling of mirror adapter 200 to mirror receiver 106 attached to handlebars 104. Second coupling mechanism 504 facilitates the coupling of mirror adapter 200 to mirror assembly 102. Dampening assembly 506 is positioned between first and second coupling mechanisms 502 and 504 and minimizes the transfer of vibration from first coupling mechanism 502 to second coupling mechanism 504.

Lock assembly 508 provides a means for locking equipment (e.g., helmet, jacket, gloves, etc.) to mirror adapter 200 using a key 510 (FIG. 5A). When in the locked position (FIG. 5A), a lock shank 512 of lock assembly 508 is locked in place. To unlock lock assembly 508, key 510 is inserted into a barrel lock 514 and rotated until a spring button 516 releases and protrudes from barrel lock 514 and shank 512 is released. Once released, shank 512 is free to move upward and to rotate about an axis 518 (FIG. 5B). Optionally, barrel lock 514 can be a “¼-turn lock” to facilitate easy, one-handed unlocking by a 90-degree turn of key 510. To lock shank 512, the open end of shank 512 is rotated into position and moved downward into seat 520. Once the open end of shank 512 is in seat 520, spring button 516 is pressed back into barrel lock 514, which locks shank 512 in within seat 520.

Barrel locks, such as barrel lock 514, are commercially available. One such barrel lock is model MK506 (“Mini Tubular Push Lock”) available from Xiamen Make Security Technology Co., Ltd. of Xiamen, China (www.makelocks.com).

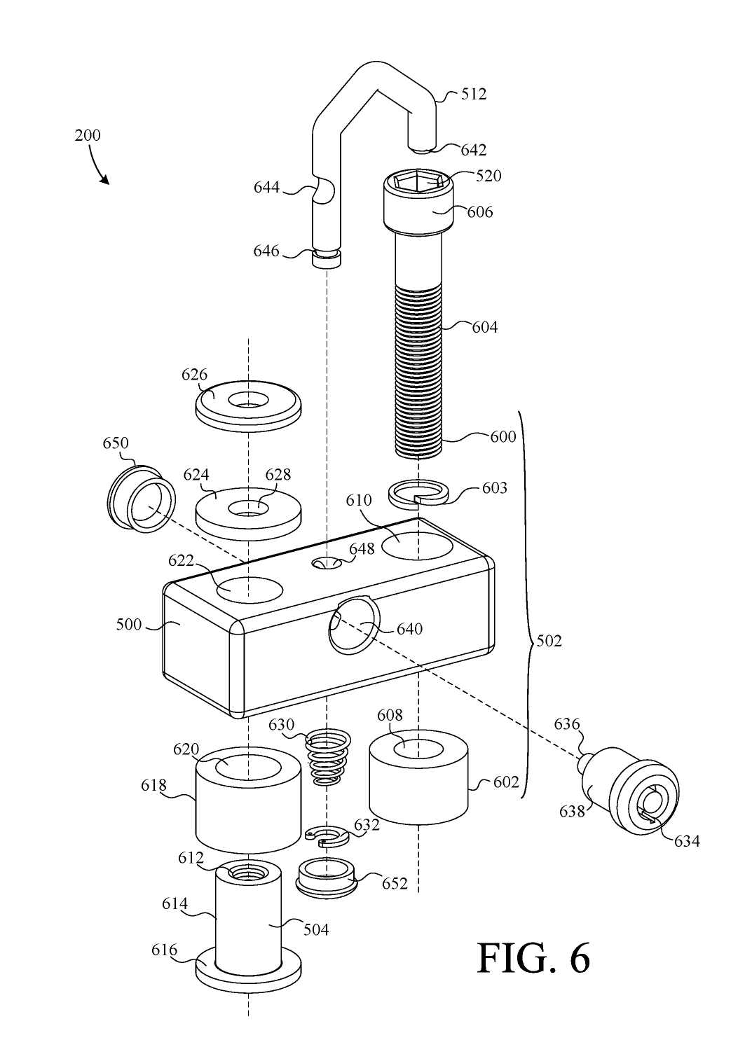

FIG. 6 is an exploded front perspective view of mirror adapter 200. Specifically, the components of first coupling mechanism 502, second coupling mechanism 504, dampening assembly 506, and lock assembly 508 are shown exploded from body 500.

First coupling mechanism 502 includes a fastener (bolt) 600, a spacer 602, and a lock washer 603. Bolt 600 includes a male threaded shank 604 extending from a head 606. Shank 604 has the same thread specification as threaded end 120 of coupling component 114 such that it is configured to thread into threaded aperture 112 of mirror receiver 106. Head 606 includes a hexagonal socket recess that defines seat 520 as well as facilitates the tightening of bolt 600 into threaded aperture 112 using, for example, a hex key (e.g. an Allen wrench). The socket recess of head 606 thus seats lock shank 512 when adapter is in a locked position. Spacer 602 is configured to be disposed between body 500 and mirror receiver 106 to provide clearance between mirror adapter 200 and underlying components (e.g., control switch 108) mounted to handlebars 104. In this example, spacer 602 is an annular member having an aperture 608, which coaxially receives shank 604. However, spacer 602 can be sized, shaped, tapered, etc. to accommodate for nearby vehicle components. Optionally, a plurality of spacers 602 can be provided of different thicknesses (heights) and/or that are configured to be stacked coaxially. Lock washer 603 is a high collar split lock washer in this embodiment. During the assembly of adapter 200, bolt 600 is first disposed through lock washer 603, then through a hole 610 formed in body 500 and then through aperture 608 of spacer(s) 602. Hole 610 is recessed such that the top of head 606 is generally flush with the top surface of body 500 when installed.

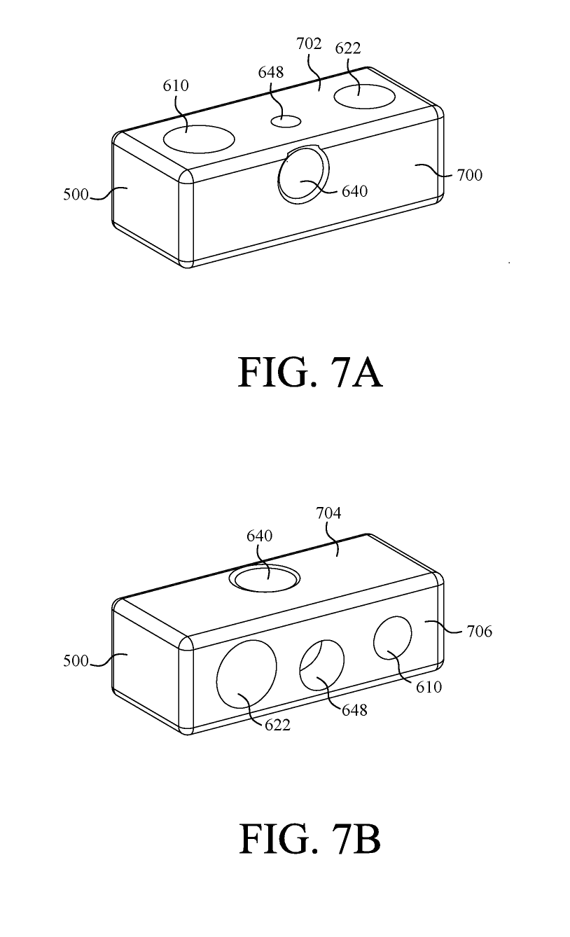

Second coupling mechanism 504 facilitates the coupling of mirror 118 to mirror adapter 200 and also facilitates the tuning of dampening assembly 506. In the example embodiment, second coupling mechanism 504 comprises a nut, which is sometimes referred to as a “T-nut”, having a female threaded hole 612, a cylindrical body 614, and a flange 616. Female threaded hole 612 has the same thread specifications as threaded aperture 112 of mirror receiver 106 and is, therefore, configured to receive the threaded end 120 of coupling component 114. Cylindrical body 614 is configured to seat a compression member 618 of dampening assembly 506. That is, body 614 is configured to be disposed within hole 620 formed through compression member 618 upon assembly of adapter 200. Flange 616 is configured to engage the bottom of compression member 618 such that compression member 618 is compressed between flange 616 and body 500 when second coupling mechanism 504 is tightened onto coupling component 114. During the assembly of mirror adapter 200, body 614 is disposed through hole 620 of compression member 618, and compression member 618 is disposed in a recessed aperture 622 formed through the bottom of body 500 (FIG. 7B). As shown, aperture 622 continues through the top of body 500.

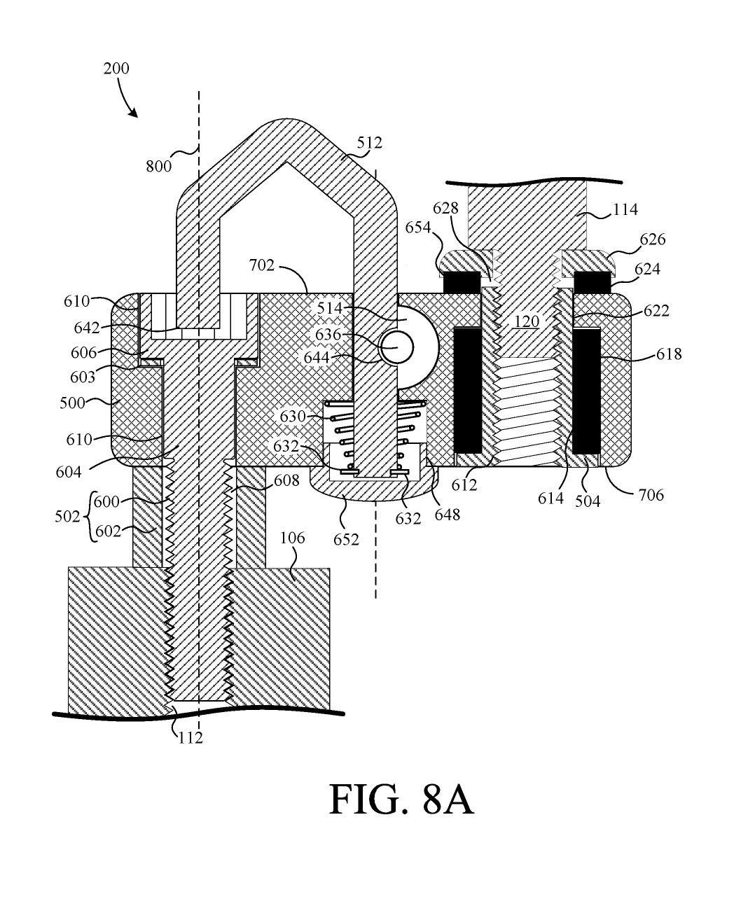

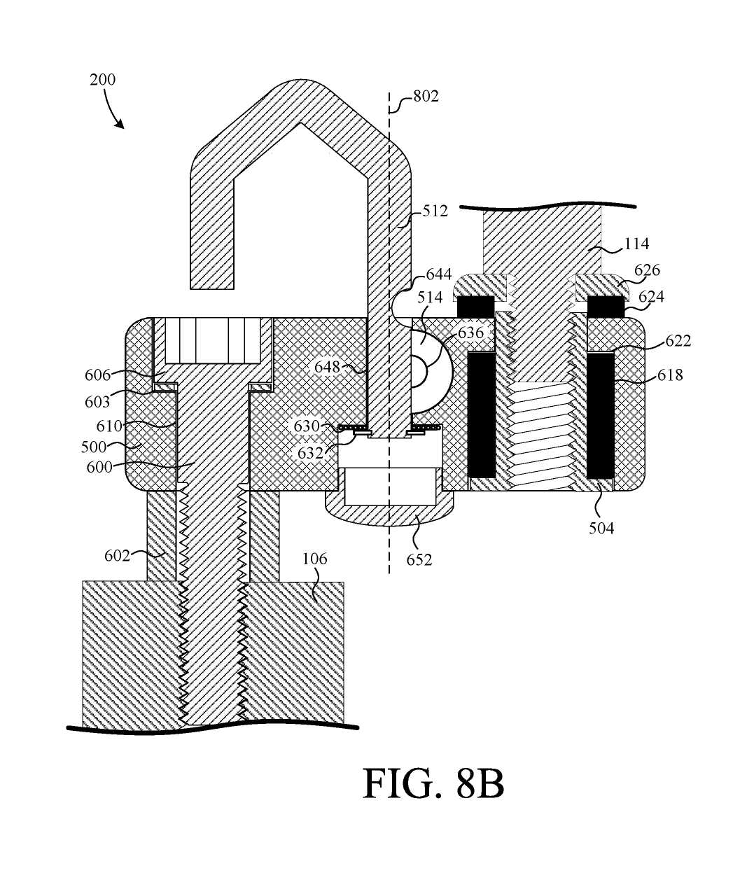

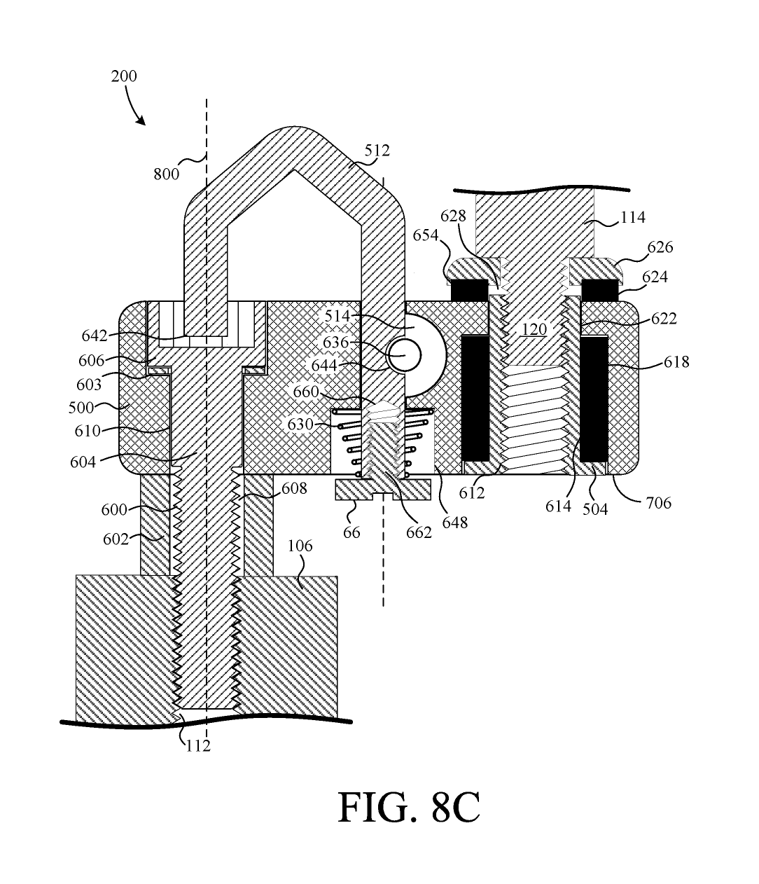

Dampening assembly 506 includes compression member 618, a compression member 624, and a washer 626. Compression member 618 is formed from a vibration dampening material such as, for example, a polymer. Compression member 624 is an annular member defining a hole 628 that is configured to receive coupling component 114 therethrough and is disposed between washer 626 and the top of body 500. Compression member 624 is also formed from a compressible material (e.g. polymer) having vibration dampening characteristics. The inventor has found that forming compression members 618 and 624 from polymers used in shock absorbers (e.g., polyurethane, neoprene, etc.), particularly those having a durometer (hardness) of Shore A30 to Shore A60, provide desirable vibration dampening characteristics and durability. Washer 626 is formed from a rigid material (e.g., aluminum, other metal, etc.) and is configured to engage coupling component 114. When coupling mechanism 504 is tightened onto coupling component 114, compression member 624 is squeezed between washer 626 and the top of body 500, and compression member 618 is squeezed between flange 616 and an inner surface of body 500 (FIGS. 8A-8B).

In the example embodiment, dampening assembly 506 is tunable to accommodate for different vibrations produced by different engines, motors, and/or vehicles. For example, if mirror 118 is vibrating due to a particular engine's vibration characteristics (e.g., engine frequency, amplitude, operating RPM, etc.), then coupling mechanism 504 can be tightened or loosened to attenuate the vibrations. By tightening or loosening coupling mechanism 504, the amount of compression exerted on compression members 618 and 624 and on washer 626 changes, thus changing the vibration transferred to mirror 118. If an engine's vibration characteristics are out of the range achievable by tightening or loosing coupling mechanism 504, compression members 618 and/or 624 can be interchanged with other compression members having different vibration dampening characteristics (e.g., materials having different durometer (hardness), density, elasticity, dimensions, etc.). Likewise, washer 626 can be interchanged with other washers having different vibration dampening characteristics (e.g., different density, dimensions, etc.). Moreover, a manufacturer can package mirror adapter 200 with multiple compression members and multiple washers to accommodate for a wide range of possible vibration characteristics. The interchangeable compression members can have different vibration dampening parameters including, but not limited to, physical dimension, mass, density, durometer (hardness), elasticity, compressibility, material type, etc.

The flexibility in vibration dampening is a particularly beneficial aspect of the present invention, because of the great number of engine configurations (e.g., single cylinder, V-twin, inline 3, inline 4, V6, V8, flat/boxer style, etc.) and displacements on the market. Additionally, it is common for engines to create a “buzz” in side mirrors when the engine operates at a particular revolutions-per-minute (RPM) or at a particular vehicle speed, which is annoying to the operator. The tunable dampening assembly of the present invention thus enables such “buzz points” to be eliminated, reduced, or changed to a different RPM/speed at which the vehicle is not commonly operated. Moreover, the tunable dampening assembly 506 also facilitates attenuating vibrations caused by vehicle suspension dynamics, electric motors, etc.

With reference again to FIG. 6, lock assembly 508 includes barrel lock 514, shank 512, a spring 630, and a retainer (C-clip) 632. Barrel lock 514 includes a key receiver 634, a shaft 636, and a cylindrical outer surface 638. Key receiver 634 provides a mechanical interface between key 510 and locking components (e.g. pins, tumbler, etc.) within barrel lock 514. Shaft 636 is adapted to protrude from the back of barrel lock 514 when barrel lock 514 is in a locked position and retract back into barrel lock 514 when in the unlocked position. Cylindrical outer surface 638 is adapted to be compression fit into an aperture 640 passing completely through body 500. In other embodiments, outer surface 638 and the inside of aperture 640 can be threaded such that barrel lock 514 can be screwed into aperture 640.

Shank 512 includes an open end 642, a notch 644, and a channel 646. Open end 642 is adapted to be seated in the hex socket recess (seat 520) of recessed head 606 when lock assembly 508 is in a locked position such that shank 512 cannot rotate. Notch 644 is configured to receive shaft 636 when barrel lock 514 is in a locked position, thus preventing open end 642 of shank 512 from being removed from recessed head 606. Oppositely, shaft 636 retracts from notch 644 when barrel lock 514 is unlocked. Channel 646 is adapted to receive c-clip 632, which prevents shank 512 from being removed from a recessed aperture 648 passing through body 500. Spring 630 is a variable radius spring that, when compressed, occupies less space than a traditional fixed radius coil spring. Spring 630 is configured to be disposed around shank 512, between c-clip 632 and body 500 so as to exert a downward force on shank 512.

In the present embodiment, the centers of apertures 610 and 622 are coaxially aligned, but aperture 648 is decentered from apertures 610 and 622 toward the rear of body 500. This decentering accommodates the depth of barrel lock 514 and also provides a larger gap between lock shank 512 and body 500 when shank 512 is unlocked and rotated toward the rear of body 500. The larger gap enables easier fastening of items to shank 512. In other embodiments, the center of apertures 610, 622, and 648 can be coaxially aligned.

Adapter 200 also includes a pair of plugs 650 and 652 that are compression fit into the open apertures 640 and 610, respectively, in body 500. Optionally, plugs 650 and 652 can be secured and/or sealed with adhesive. Plugs 650 and 652 can be formed from any suitable material, such as plastic, metal (e.g., for added security against tampering), etc.

FIG. 7A is a perspective view of body 500 showing a back surface 700 and top surface 702. FIG. 7B is a perspective view of body 500 showing a front surface 704 and a bottom surface 706. Notably, aperture 640 has a uniform diameter and passes completely through body 500 from back surface 700 to front surface 704. Additionally, FIGS. 7A and 7B illustrate that apertures 610, 648, and 622 are recessed (have varying diameters) and pass completely through body 500 from top surface 702 to bottom surface 706.

FIG. 8A is a cross-sectional, rear view of mirror adapter 200 taken along line A-A of FIG. 5A and shown in a locked state. (Note line A-A is bent and travels through the centers of each of apertures 622, 648, and 610.) Additionally, first coupling mechanism 502 is shown mounted to mirror receiver 106, and coupling component 114 of mirror assembly 102 is shown mounted to second coupling mechanism 504. More particularly regarding first coupling mechanism 502, bolt 600 is disposed through lock washer 603, aperture 610 of body 500, aperture 608 of spacer 602, and is threaded into threaded aperture 112 of mirror receiver 106. As shown, lock washer 603 is compressed between recessed head 606 and body 500, has an inner diameter slightly larger than the outer diameter of shank 604, and has an outer diameter slightly smaller than the diameter of aperture 610 through top surface of body 500. Regarding second coupling mechanism 504, threaded end 120 of coupling component 114 is disposed through a center aperture of washer 626, aperture 628 of compression member 624, aperture 622 of body 500, and is threaded into threaded aperture 612 of second coupling mechanism 504.

Mirror adapter 200 is tightly fixed with respect to mirror receiver 106 by tightening bolt 600 such that spacer 602 is squeezed between bottom 706 of body 500 and the top of mirror receiver 106. The position of body 500 about an axis 800 passing through bolt 600 can be changed (e.g., for personal preference, to avoid a control switch, etc.) by loosening bolt 600 and rotating body 500. Once body 500 is properly positioned, bolt 600 is retightened to fix body 500 in place with respect to mirror receiver 106.

Second coupling mechanism 504 is configured to substantially minimize direct contact with body 500. For example, compression member 618 is disposed between cylindrical body 614 and body 500 to minimize the vibration transferred from body 500 to coupling mechanism 504. If vibration does transfer from body 500 to mirror 118, the vibration dampening characteristics of compression members 618 and 624 can be changed by changing the amount of compression exerted thereon. For example, tightening (screwing) coupling component 114 into threaded aperture 612 causes second coupling mechanism 504 and washer 626 to urge toward one another. When coupling mechanism 504 and washer 626 are urged toward one another, the compressive force exerted on compression members 618 and 624 increases. As a result, the vibration dampening characteristics of compression members 618 and 624 change.

As mentioned above, the vibration dampening characteristics of mirror adapter 200 can also be changed by loosening (unscrewing) coupling component 114, changing compression members 618 and/or 624 out in favor of element(s) having more desirable vibration damping characteristics (e.g., different durometer (hardness) values, etc.), adding compression members 624, and/or substituting a washer 626 with different vibration characteristics. Even second coupling mechanism 504 could itself be swapped in favor of a coupling mechanism 504 with different vibration characteristics (e.g., larger mass, etc.). The flexibility in tuning the amount of vibration damping provides a particularly beneficial aspect of the invention.

The cylindrical body 614 of T-nut 504 is also shown to protrude slightly (e.g., ⅛ inch or less, etc.) above the top surface of body 500. This feature provides centering of compression member 624 via its center aperture 628 and ensures that the threaded end 120 coupling component 114 can sufficiently thread into threaded aperture 612 of T-nut 504 securely receive its threaded end 122 therein. Additionally, washer 626 is shown to include a recessed bottom 654, which facilitates centering washer 626 on compression member 624. Washer 626 also prevents damage to compression member 624 when coupling component 114 is tightened. It should also be noted here that second coupling mechanism 504 utilizes a piece of stock mirror assembly 102, in this case coupling component 114, to provide compression for dampening. In other embodiments, however, the second coupling mechanism 504 can include additional component(s) to engage threaded aperture 612 of cylindrical body 614. For example, in an alternative embodiment, second coupling mechanism 504 can include a threaded member configured to engage the top of washer 626 and thread into threaded aperture 612, so as to squeeze washer 626, compression member 624, and compression member 618 together. Such threaded member can also be configured to have a stock mirror assembly of a vehicle mounted to it. Accordingly, the second coupling mechanism 504 can be customized to mount and dampen a wide variety of stock mirrors thereto, while retaining damping function.

FIG. 8A further shows that when mirror adapter 200 is in the locked state, shaft 636 of barrel lock 514 is disposed in notch 644 of lock shank 512, thereby preventing shank 512 from moving upward. By preventing shank 512 from moving upward, open end 642 cannot be removed from the recessed head 606 of bolt 600, and for the same reason, bolt 600 cannot be removed from mirror receiver 106. When open end 642 is positioned in recessed head 606, spring 630 is decompressed as shown. Spring 630 is positioned about shank 512 in the recessed portion of aperture 648 between C-clip 632 and body 500. Plug 652 is secured (e.g., by glue, compression fit, etc.) in aperture 648 to inhibit corrosion and provide added security. Plug 652 is domed in this example embodiment but, in alternative embodiments, can be made flush with the bottom surface 706 of body 500 (e.g., by resizing shank 512 and body 500 accordingly, etc.). Plug 650 (FIG. 6) is likewise be inserted through the rear surface 700 of body 500 to close the rear of aperture 640.

FIG. 8B is a cross-sectional, rear view of mirror adapter 200 taken along line B-B of FIG. 5B and shown in an unlocked position. (Line B-B also travels through the centers of each of apertures 622, 648, and 610.) When in the unlocked position, shaft 636 is retracted from notch 644 and into barrel lock 514. This allows shank 512 to rotate about, and move along, an axis 802. Of course, the travel along axis 802 is limited by C-clip 632. When shank 512 is pulled upward to the uppermost limit, spring 630 is completely compressed. Because spring 630 has a variable radius, it compresses within itself such that the vertical height is equivalent to the thickness of approximately one coil. This allows shank 512 to have a greater distance of upward travel per decompressed height as compared to constant-radius coil springs.

FIG. 8C is another cross-sectional rear view of the adapter of FIG. 2 in a locked state taken along line A-A of FIG. 5A, which shows an alternative means for mounting spring 630 around shank 512. In FIG. 8C, the bottom end of shank 512 is bored and tapped to define a threaded aperture 660. During assembly, once spring 630 is installed around shank 512, a set screw 662 is screwed into threaded aperture 660 to secure spring 630 between body 500 and a head 664 of set screw 662. Further, the outer diameter of head 664 is sized to be slightly smaller than the diameter of recessed aperture 648 through bottom surface 706 of body 500. Thus, the close fit between aperture 648 and head 664 provides security against tampering, a wide abutment for spring, and laterally stabilizes shank 512 through its range of vertical travel.

As will be apparent from the foregoing description, the components of mirror adapter 200 can be made in a variety of sizes and for a variety of different types, makes, and models of vehicles. For example, body 500 can be made approximately one inch square by three inches long, made of aluminum, and can be anodized for color for one vehicle, but be made with different dimensions, colors, etc. for a different vehicle. Similarly, compression member 618 can be approximately ⅝ inches in height, have inner and outer diameters of approximately ½ and ¾ inches, respectively, for one application, but be made taller, wider, etc. for a different application. Compression member(s) 624 can be provided in any desirable diameter (e.g., ¾ inch, etc.) and thickness (e.g., ⅛ inch, 2/10 inch, ¼ inch, etc.). Optionally, a set of compression members 626 can be provided and color-coded based on vibration damping properties (e.g., based on Shore value, for low, medium, high damping, etc.). Dimensions of washer 626 can be similarly customized per application.

Additionally, alterations can be made to mirror adapter 200 without departing from the spirit and scope of the present invention. For example, a vibration dampening assembly, including one or more compression member(s), can be provided and compressed between bolt 600 and body 500 and/or body 500 and spacer 502, etc. In a specific example, a compression member with a central aperture (e.g., similar to compression member 618, etc.) can be installed around shank 604 of bolt 600 in a bottom recess of aperture 610 formed in body 500. The compression exerted on such compression member between body 500 and spacer 602 can be adjusted by tightening and loosening bolt 600 as desired. Even more specifically, such a compression member can include a keyway (a groove, etc.) that accepts a key (a protrusion, etc.) formed in aperture 610, for example, to resist rotation of such compression member. Additionally or alternatively, such a compression member could be press fit into aperture 610 with a tight tolerance. Indeed, in some embodiments, it might be desirable to press fit compression member 618 into recessed aperture 622 and/or provide compression-member alignment structures between compression members 618, 624 and body 500.

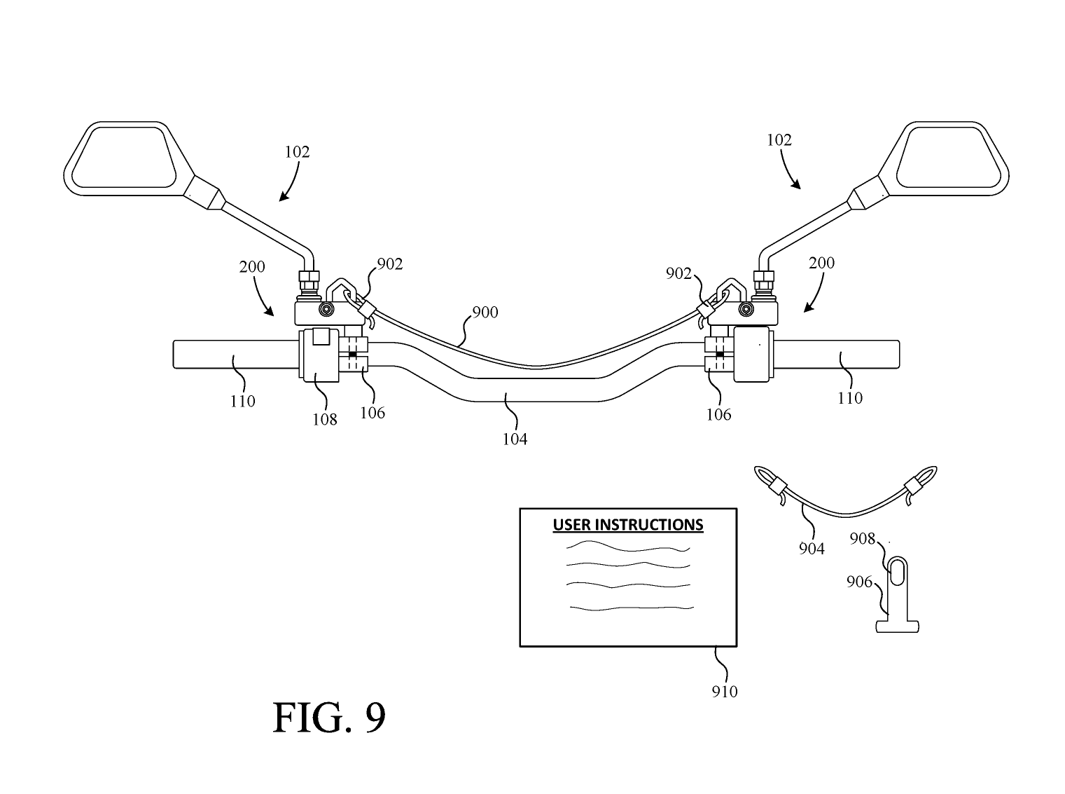

FIG. 9 is a front view of two mirror adapters 200 mounted on opposite sides of handlebars 104, with a security cable 900 coupled therebetween. Security cable 900 is, for example, a plastic coated steel cable having looped ends 902, each being configured to be locked to a respective one of mirror adapters 200. Security cable 900 provides a means for locking large riding gear (i.e., jackets, pants, helmets, etc.) and/or other items to handlebars 104. For example, a rider can thread cable 900 through the sleeves of a riding jacket and then lock looped ends 902 to respective adapters 200 to prevent the jacket from being stolen when the vehicle is left unattended. Security cable 900 can also be used with a single mirror adapter 200 by locking both looped ends 902 into a single adapter 200. Indeed, mirror adapters 200 can be packaged to include multiple security cables having varying lengths, such as short security cable 904. Other adapters, such as T-adapter 906, can also be included. T-adapter 906 includes an aperture 908 and is useful for securing helmets with chinstraps having ratchet-style clasps.

Instructions 910 can be provided with mirror adapter 200 to instruct a user/operator how to install and position mirror adapter 200, how to tune the dampening assembly 508 to reduce mirror vibrations (e.g., by interchanging compression members, etc.), and/or how to use the lock assembly 508. The instructions 910 can be attached to the mirror adapter 200 itself (e.g., via a removable tie), attached to packaging, included as a packaging insert, etc.

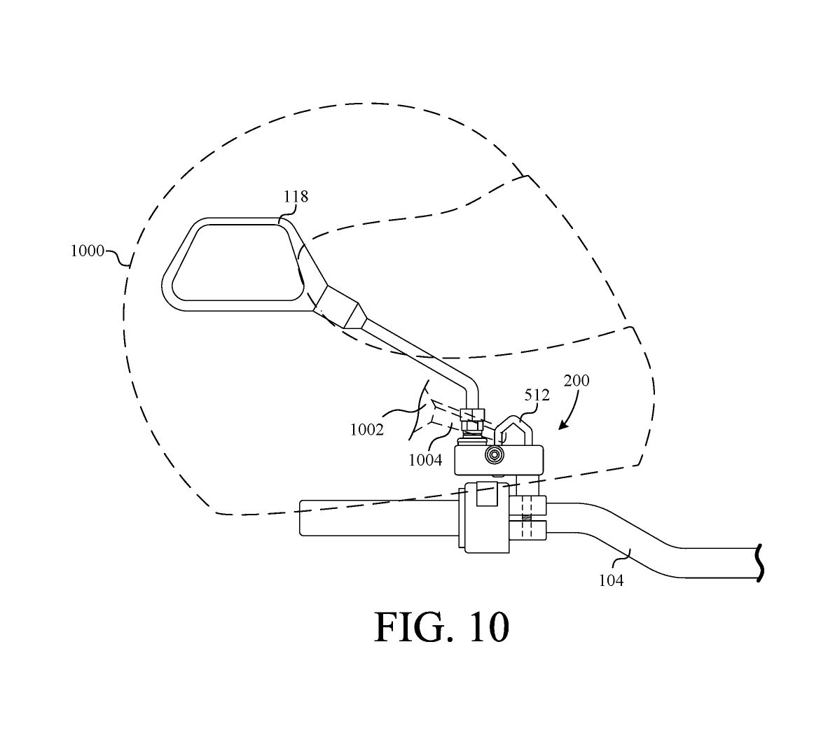

FIG. 10 is a side view of mirror adapter 200 showing a helmet 1000 locked thereto. Specifically, helmet includes a chinstrap 1002 having a clasp 1004 (e.g., one or more D-rings, a ratchet mechanism, etc.). In the specific case of a D-ring, with mirror adapter 200 in its unlocked position, shank 512 is passed through D-ring 1004. Shank 512 is then rotated such that open end 642 is positioned in recessed head 606. Spring button 516 can then be pressed to engage barrel lock 514 and lock helmet 1000 to mirror adapter 200. Alternatively, clasp 1004 can be locked to mirror adapter 200 indirectly via a secondary securing device like short cable 904, T-adapter 906, etc. For example, in the case of helmet 1000 having a chinstrap with a ratchet-style clasp, T-adapter 906 can be inserted through the ratchet strap path and secured to shank 512 via aperture 908. Advantageously, FIG. 10 also shows how mirror adapter 200 allows helmet 1000 to be secured in an upright position, over mirror 118, such that both the interior of helmet 1000 and mirror 118 will stay dry during rain and snow.

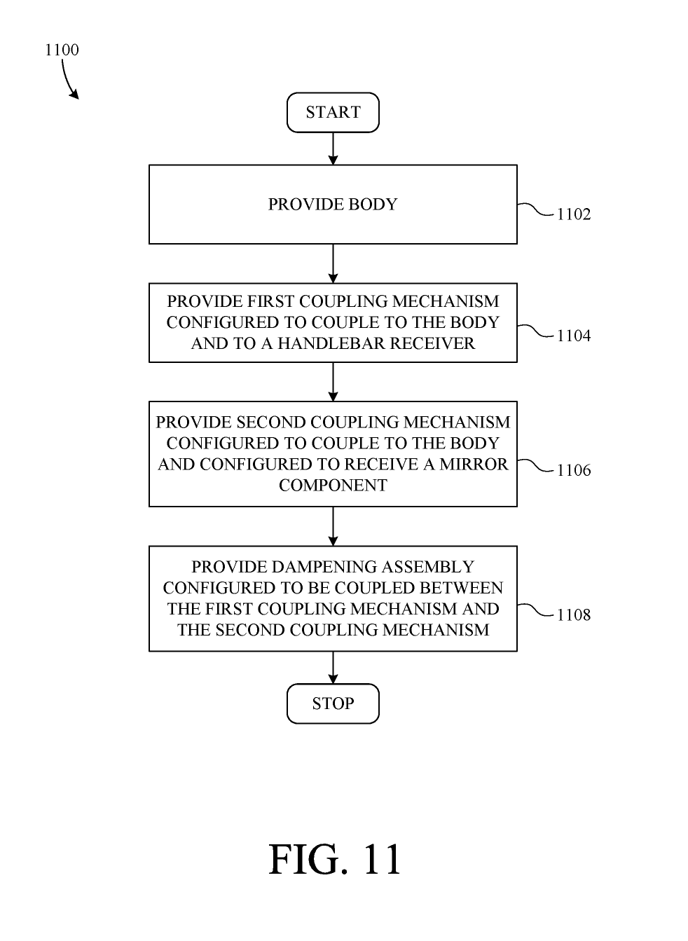

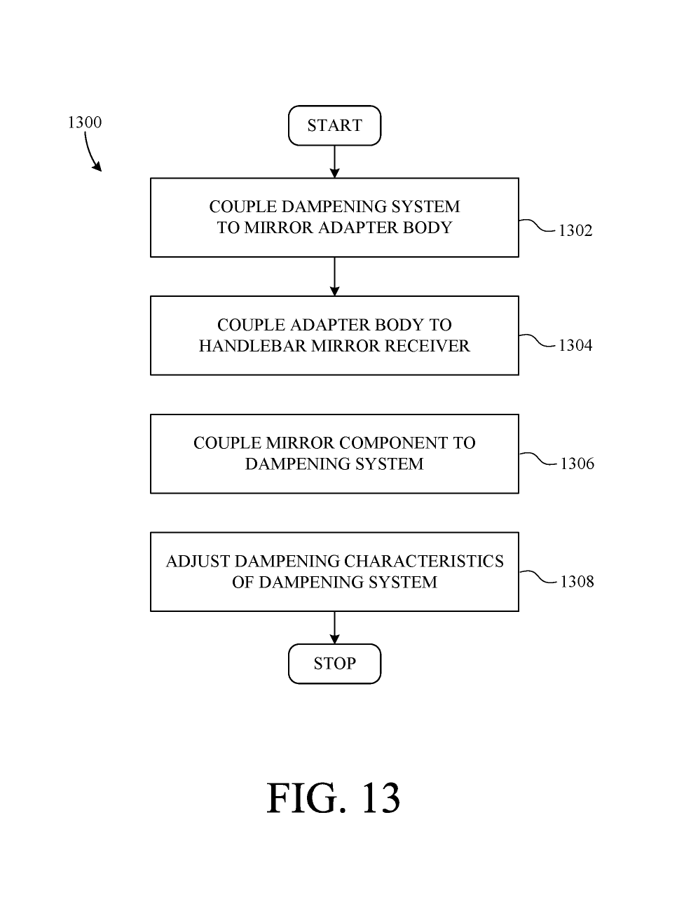

Methods of the present invention will now be described with reference to FIGS. 11-13. For the sake of clear explanation, these methods might be described with reference to particular elements of the previously-described embodiments. However, it should be noted that other elements, whether explicitly described herein or created in view of the present disclosure, could be substituted for those cited without departing from the scope of the present invention. Therefore, it should be understood that the methods of the present invention are not limited to any particular elements that perform any particular functions. Furthermore, some steps of the methods presented herein need not necessarily occur in the order shown. For example, in some cases two or more method steps may occur simultaneously. These and other variations of the methods disclosed herein will be readily apparent, especially in view of the description of the present invention provided previously herein, and are considered to be within the full scope of the invention.

FIG. 11 is a flowchart summarizing a method 1100 of manufacturing a mirror adapter. In a first step 1102, a body is provided. In a second step 1104, a first coupling mechanism configured to couple to the body and to a handlebar receiver is provided. In a third step 1106, a second coupling mechanism configured to couple to the body and to receive a mirror component is provided. In a fourth step 1108, a dampening assembly configured to be coupled between the first coupling mechanism and the second coupling mechanism is provided.

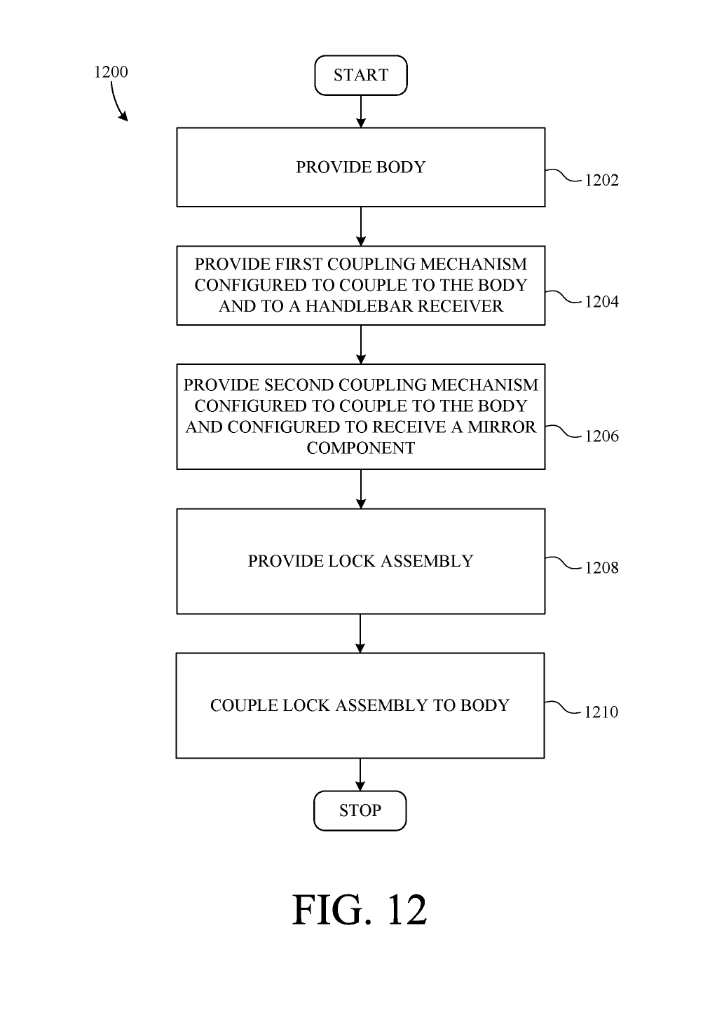

FIG. 12 is a flowchart summarizing another method 1200 of manufacturing a mirror adapter. In a first step 1202, a body is provided. In a second step 1204, a first coupling mechanism configured to couple to the body and to a handlebar receiver is provided. In a third step 1206, a second coupling mechanism configured to couple to the body and to receive a mirror component is provided. In a fourth step 1208, a lock assembly is provided, and in a fifth step 1210, the lock assembly is coupled to the body.

FIG. 1300 is a flowchart summarizing a method 1300 for installing a mirror adapter on a vehicle. In a first step 1302, a dampening system is coupled to a mirror adapter body. Then, in a second step 1304, an adapter body is coupled to a handlebar mirror receiver (e.g., after removing the stock mirror assembly). Next, in a third step 1306, a mirror component is coupled to the dampening system. Finally, in a fourth step, the dampening characteristics of the dampening system are adjusted to attenuate vibration in the mirror. Advantageously, if observed vibration in the mirror is still too great during operation of the vehicle, then the dampening system can be readjusted, such as by interchanging, adding, and/or removing compression members having different damping characteristics, increasing compression in the compression members, etc.

The description of particular embodiments of the present invention is now complete. Many of the described features may be substituted, altered or omitted without departing from the scope of the invention. For example, alternative dampening materials (e.g., rubber, plastics, etc.), may be substituted for the polymer material of the compression members. As another example, alternative lock types may be substituted for the barrel lock. As still another example, a mirror adapter could be provided with only one of a dampening assembly and lock assembly and omitting the other. These and other deviations from the particular embodiments shown will be apparent to those skilled in the art, particularly in view of the foregoing disclosure.

1. A mirror adapter comprising:
a body having a top and a bottom;
a first coupling mechanism coupled to said body and configured to couple to a handlebar mirror receiver of a vehicle;
a second coupling mechanism coupled to said body and configured to receive a mirror component; and
a dampening assembly coupled between said first coupling mechanism and said second coupling mechanism and configured to dampen vibration between said first coupling mechanism and said second coupling mechanism.

2. The mirror adapter of claim 1, wherein said first coupling mechanism includes at least one spacer configured to be disposed between said bottom of said body and said handlebar mirror receiver of said vehicle.

3. The mirror adapter of claim 1, wherein:
said first coupling mechanism includes an aperture extending through said top of said body to said bottom of said body;
said first coupling mechanism includes a fastener disposed in said aperture; and
said fastener is configured to thread into said handlebar mirror receiver of said vehicle.

4. The mirror adapter of claim 3, wherein;
said mirror adapter further comprises a lock shank having an open end;
said fastener includes a head defining a socket recess; and
said open end of said lock shank is configured to be removably disposed in said socket recess.

5. The mirror adapter of claim 1, wherein:
said second coupling mechanism includes a nut configured to threadably engage said mirror component;
said dampening assembly includes a compression member disposed between said nut and said body; and
changing the amount of force exerted on said compression member by said nut and said body alters the vibration characteristics of said mirror component.

6. The mirror adapter of claim 5, wherein said nut includes a flange configured to engage said compression member.

7. The mirror adapter of claim 6, wherein said compression member has an annular geometry and is disposed around said nut.

8. The mirror adapter of claim 5, wherein:
a portion of said body defines an aperture extending through said top of said body to said bottom of said body, said aperture being configured to receive said mirror component;
at least a portion of said compression member is disposed in said aperture; and
said compression member compresses between said flange of said nut and said portion of said body defining said aperture responsive to tightening said nut onto said mirror component.

9. The mirror adapter of claim 5, further comprising:
a second compression member disposed between said top of said body and said mirror component; and wherein
changing the amount of compressive force exerted on said second compression member by said body and said mirror component alters the vibration characteristics of said mirror component.

10. The mirror adapter of claim 9, further comprising a washer configured to engage said second compression member, said second compression member being disposed between said top of said body and said washer.

11. The mirror adapter of claim 5, wherein said compression member is one of a plurality of interchangeable compression members, each of said plurality of compression members having different vibration-reducing characteristics.

12. The mirror adapter of claim 5, wherein said compression member comprises a polymer material.

13. The mirror adapter of claim 1, wherein said dampening assembly includes a compression member disposed between said top of said body and said mirror component.

14. The mirror adapter of claim 13, wherein said compression member is one of a plurality of interchangeable compression members, each of said plurality of compression members having different vibration-reducing characteristics.

15. The mirror adapter of claim 13, wherein said dampening assembly further includes a washer configured to engage said compression member, said compression member being disposed between said top of said body and said washer.

16. The mirror adapter of claim 15, wherein said washer is one of a plurality of interchangeable washers, each of said plurality of interchangeable washers having different vibration-reducing characteristics.

17. The mirror adapter of claim 1, further including a locking mechanism coupled to said body.

18. The mirror adapter of claim 17, wherein said locking mechanism includes a lock shank.

19. The mirror adapter of claim 18, wherein said locking mechanism includes a barrel lock configured to selectively engage said lock shank.

20. The mirror adapter of claim 18, wherein said locking mechanism includes a variable radius coil spring disposed around said lock shank.

21. The mirror adapter of claim 18, wherein:
said first coupling mechanism includes an aperture extending through said body from said top to said bottom;
said first coupling mechanism includes a bolt disposed in said aperture;
said bolt is configured to thread into said handlebar mirror receiver of said vehicle;
said bolt includes a head defining a socket recess;
said lock shank includes an open end;
said open end of said lock shank is disposed in said socket recess when said locking mechanism is in a locked position and removed from said socket recess when said locking mechanism is in an unlocked position;
said second coupling mechanism includes a nut configured to threadably engage said mirror component;
said dampening assembly includes a compression member disposed between said nut and said body; and
changing the amount of force exerted on said compression member by said nut and said body alters the vibration characteristics of said mirror component.

22. The mirror adapter of claim 1, wherein said dampening assembly is tunable.

23. The mirror adapter of claim 1, wherein said second coupling mechanism is horizontally offset with respect to said first coupling mechanism such that said body can be adjustably fixed about an axis passing through said first coupling mechanism.

24.-29. (canceled)

30. A method of manufacturing a mirror adapter, said method comprising:
providing a body having a top and a bottom;
providing a first coupling mechanism configured to couple to said body and further configured to couple to a handlebar mirror receiver of a vehicle;
providing a second coupling mechanism configured to couple to said body and further configured to receive a mirror component; and
providing a dampening assembly configured to be coupled between said first coupling mechanism and said second coupling mechanism and further configured to dampen vibration between said first coupling mechanism and said second coupling mechanism.

31. The method of claim 30, wherein said step of providing said dampening assembly includes:
selecting a compression member from a plurality of compression members based on a model of said vehicle, each of said plurality of compression members having different vibration-reducing characteristics; and
providing said selected compression member as a component of said dampening assembly.

32. The method of claim 30, wherein said step of providing said dampening assembly includes providing a plurality of interchangeable compression members, each of said plurality of compression members having different vibration-reducing characteristics.

33. The method of claim 32, wherein said step of providing said first coupling mechanism includes providing a fastener configured to be disposed through said body and threaded into said handlebar mirror receiver of said vehicle.

34. The method of claim 33, wherein:
said step of providing said first coupling mechanism includes providing one or more spacers configured to be disposed around said fastener between said body and said handlebar mirror receiver; and
each of said one or more spacers is configured to raise said body above said handlebars by a predetermined amount.

35. The method of claim 30, wherein said step of providing said second coupling mechanism includes providing a nut having thread specifications corresponding to said mirror component.

36. The method of claim 35, wherein:
said step of providing said dampening assembly includes providing a plurality of interchangeable compression members;
each of said plurality of compression members has a different vibration reducing characteristic; and
each of said plurality of compression member is configured to be disposed between said nut and said body.

37. The method of claim 30, wherein said step of providing said dampening assembly includes:
providing a rigid washer configured to be disposed between said body and said mirror component; and
providing a compression member configured to be disposed between said rigid washer and said body.

38. The method of claim 37, wherein said step of providing said dampening assembly includes providing a plurality of interchangeable rigid washers configured to be disposed between said body and said mirror component, each of said rigid washers having a different vibration characteristic.

39. The method of claim 37, wherein said step of providing said dampening assembly includes providing a plurality of interchangeable compression members configured to be disposed between said body and rigid washer, each of said compression members having a different vibration characteristic.

40. The method of claim 30, further comprising providing a lock assembly configured to lock objects to said mirror adapter.

41. (canceled)

42. A method for installing a mirror adapter on a vehicle, said method comprising:
installing a dampening system on a body of said mirror adapter;
fastening said body to a handlebar mirror receiver of said vehicle via a first coupling mechanism;
fastening a mirror component to said body via a second coupling mechanism, said second coupling mechanism configured to adjustably compress said dampening system between said second coupling mechanism and said body; and
adjusting said second coupling mechanism to apply compression on said dampening system sufficient to dampen vibration on said mirror component during operation of said vehicle.

43. The method of claim 42, further comprising:
observing vibration in said mirror component during operation of said vehicle; and
adjusting said compression on said dampening system to change the amount of vibration occurring in said mirror component during operation of said vehicle.

44. The method of claim 42, wherein:
said dampening system comprises a plurality of interchangeable compressible members, each compressible member having a different vibration characteristic; and
said step of installing said dampening system includes installing a one of said interchangeable compressible members between said second coupling mechanism and said body.

45. The method of claim 44, further comprising:
observing vibration in said mirror component during operation of said vehicle; and
installing a different one of said interchangeable compressible members between said second coupling mechanism and said body if said observed vibration in said mirror is too great.
